(19) United States
(12) Patent Application Publication
(10) Pub. No.: US 2022/0166220 A1
(43) Pub. Date: May 26, 2022

(54) ELECTRICAL ENERGY SUPPLY METHOD

(71) Applicant: Power Edison LLC., Watchung, NJ (US)

(72) Inventors: Shihab Kuran, Watchung, NJ (US); Yazan Harasis, Watchung, NJ (US); Husam Kuran, Watchung, NJ (US)

(73) Assignee: Power Edison LLC., Watchung, NJ (US)

(21) Appl. No.: 17/529,510

(22) Filed: Nov. 18, 2021

Related U.S. Application Data
(60) Provisional application No. 63/116,673, filed on Nov. 20, 2020.

(51) Int. Cl. H02J 3/32; H02J 7/00; B60L 55/00; B60L 53/20; B60L 50/60

(52) U.S. Cl. CPC H02J 3/322; H02J 7/0013; H02J 7/0047; H02J 7/007; B60L 55/00; B60L 2200/36; B60L 50/60; H02J 2310/42; H02J 2207/20; B60L 2200/32; B60L 53/20

(57) ABSTRACT

Disclosed is a method for the delivery of electric power to a power consumption site with two or more mobile systems. The method includes charging a first one of the two mobile systems, moving the charged first mobile system to a location in the vicinity of the site, connecting the mobile system to the site, charging a second one of the mobile systems at a location in the vicinity of a power plant or a functional power infrastructure, moving the charged second mobile system to the location in the vicinity of the site, and replacing the first mobile system with the second mobile system to supply electric power to the site from the second mobile system.

### CROSS REFERENCE TO RELATED APPLICATIONS

The present application claims priority to U.S. Provisional Patent Appl. No. 63/116,673, filed Nov. 20, 2020, which is incorporated in its entirety by reference.

### FIELD OF THE INVENTION

The present invention relates to a method of delivering energy, particularly electrical energy, from a mobile electrical energy storage system (hereafter “mobile system”) that can travel on land or in a marine environment, for example, navigable waterways.

### BACKGROUND OF THE INVENTION

Electric power is a crucial and essential component of everyday life. The ability to use electricity on demand directly impacts the quality of life. Electric power for a site (a home, a school, a commercial building, an industrial entity, etc.) can be generated on site in some cases but is mainly generated elsewhere and transported to the site via an electrical transmission and distribution system, referred to as a grid. A grid is typically owned and operated by a utility company. An electric power generation plant (hereafter “power plant”) can connect to a grid directly to supply electric power to various sites. Multiple power plants can supply power to sites connected to a grid.

Any disruption to a grid due to maintenance, storms, hurricanes etc. can cause widespread electric outages to the sites that are connected to the grid. Power plants can often remain online during grid outages, but the electricity cannot be transported due to the grid disruptions. During outages, an entity, for example, a hospital, may use backup generators that are usually gas or diesel powered. However, these generators are often not big enough to power the entire electric load of the entity. Moreover, the backup generators are very polluting and cause health issues due to the emitted particulates. Back up generators are used until the grid is restored and electricity can flow through the grid, which can sometimes take several weeks. In flood prone areas, it can be especially challenging to restore the grid due to the inability to access the roadways. Natural disasters leading to electric outages are becoming increasingly common with higher frequency of occurrences due to global warming and climate change.

### SUMMARY OF THE INVENTION

A general object of the present invention is to supply power to an entity that consumes electricity (hereafter “site”) located on land, from a marine environment, for example.

Another object of the present invention is to supply electricity to a critical infrastructure site without using a grid. A site can be a wastewater treatment facility, a hospital, a train station, an emergency services building, a shelter or other critical infrastructure.

The objects of the present invention are accomplished with two or more mobile systems. Each mobile system may be deployed with a mobile marine vessel (for example, a barge) or a trailer with rechargeable electrical energy storage and electric delivery systems.

A severe weather event, such as a hurricane, can cause mass disruption of the electrical grid resulting in outages. This is usually due to the falling of poles and cables on the distribution circuit (the “last mile” delivery portion of the electric grid). Power plants, transmission lines and larger substations are usually operational since they are made resilient. Although power plants and transmission lines are functional, they cannot deliver electricity to the sites that are connected to the grid. When this occurs, two or more mobile systems, can be used to transport electricity. For example, one fully charged mobile system may be positioned at a location in the vicinity of a site where uninterrupted electricity supply is needed (before or after the outage) to supply electricity to the site. At the same time, another mobile system can be stationed at a nearby power plant or substation, with its energy storage system charging rapidly. Before the mobile system at the site is completely depleted of energy, the mobile system at the charging site will be disconnected and will travel to take over from the depleted mobile system. The fully charged mobile system may be then connected to the site to continue supplying electricity. At this time, the fully depleted mobile system can travel to a charging site to charge rapidly and the cycle can go on as long as needed.

A mobile system can include one electrical energy storage module or a plurality of electrical energy storage modules to store and supply electrical energy. Each module may be able to withstand electrical currents and may be able to quickly charge in 10 hours or less, more preferably in 8 hours or less, more preferably in 6 hours or less, more preferably in 4 hours or less, more preferably in 2 hours or less and most preferably in less than 1 hour. This may be made possible by the mechanical structure and the chemical composition of the module. The module charging rate of a given electrical energy storage module may be dictated by a power conversion module (used for the charging of the module) and its respective power rating.

A mobile system may further comprise one electrical connection apparatus or a plurality of electrical connection apparatuses to connect the power from the mobile system to a site. Preferably, an electrical connection apparatus is able to move at least in 2 degrees of freedom, more preferably at least 4 degrees of freedom, and more preferably at least 6 degrees of freedom, and most preferably at least 8 degrees of freedom to maintain electrical connection with the site when the mobile system is charging and discharging.

Preferably, the mobile system further includes at least one component selected from a group consisting of an electrochemical cell, an electrical cell, a mechanical energy storage, a flow battery and fuel cells.

Also preferably, a mobile system further includes a monitoring device or a plurality of monitoring devices to monitor the energy storage and/or the dispatch of energy as well as a control element or a plurality of control elements to control the dispatch of energy from the electrical energy storage module or modules.

Preferably, the mobile system may be implemented with a barge that most preferably comprises an on-board motor for propulsion.

A mobile system may be controlled by an individual on board, may be controlled remotely by an individual, or may be controlled autonomously.

A mobile system is preferably capable of docking at a land location and also capable of withstanding marine environments.

A mobile system has the flexibility to connect to an electric distribution system, for example, a grid, or a site or sites connected to a grid.

A mobile system may be connected either in-front-of-the-meter, behind-the-meter or both simultaneously, as decided dynamically while mobile system is deployed in the field.

These and other objects, advantages, and features of the invention will become apparent to those persons skilled in the art upon reading the details of the formulations and methods as more fully described below.

### BRIEF DESCRIPTION OF THE DRAWING

FIG. 1 shows the steps in a method according to the present invention.

FIG. 2 illustrates a mobile system that can be used in a method according to the first embodiment of the present invention.

FIG. 3 illustrates a mobile system that can be used in a method according to the present invention according to a second embodiment of the present invention.

### DETAILED DESCRIPTION OF THE INVENTION

The present invention is directed at a method of delivering electric power to a site from a mobile, rechargeable electrical energy storage system.

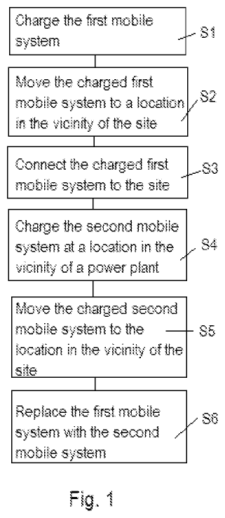

Referring to FIG. 1, in a method according to the present invention, a first mobile system is charged (S1) (for example, electric power is stored in an electric power storage module on board of the first mobile system) at a location (in a marine environment, for example) in the vicinity of an electric power plant or a functional power infrastructure. The charged first mobile system then travels (for example, in a marine environment) to a location in the vicinity of the site on land (for example, a train station, a hospital, a shelter, etc.) (S2), and electrically connects to the site (S3) to supply power to the site from the location in the vicinity of the site.

While the first mobile system supplies electric power to the site from the location in the vicinity of the site, a second mobile system is charged (S4) (i.e. electric power is stored in an electric power storage on board of the second mobile system) at a location (in a marine environment, for example) in the vicinity of an electric power plant or a functional power infrastructure, which may be the same electric power plant or functional power infrastructure that charged the first mobile system or a different electric power plant or functional power infrastructure.

A location in the vicinity of the site as used herein means any location (for example, a marine location) at which a deployed mobile system may be electrically connected to the site in order to supply electrical power to the site.

A location in the vicinity of a power plant or a functional power infrastructure as used herein means any location (for example, a marine location) at which a mobile system may be electrically connected to the power plant or the functional power infrastructure in order to receive electric power from the power plant.

Once charged, the second mobile system travels to the location in the vicinity of the site (S5) and is connected to the site to supply electric power to the site to replace (S6) the first mobile system as the supplier of electric power to the site. The second mobile system may replace the first mobile system according to any desired criteria. For example, the second mobile system may replace the first mobile system when the first mobile system does not have enough electric power stored to supply the site for more than a set period of time, for example, four hours. The electrical interconnection point on the land may be engineered to accept multiple electrical inputs. When the second mobile system reaches a location in the vicinity of the site, it may be connected to the site in parallel to the first mobile system. A software-enabled system, which is integrated into the mobile systems, then enables a smooth transition between the power supplied from the first mobile system and the second mobile system to allow for uninterruptable flow of electrical energy.

After the first mobile system is disconnected from the site, the first mobile system may travel to a location (in a marine environment, for example) in the vicinity of a power plant (or any other source of electricity), connected to the power plant, and recharged again. The first mobile system may travel to the location in the vicinity of the same power plant or functional power infrastructure at which it was originally charged or a different power plant or a different functional power infrastructure.

The first mobile system may then replace the second mobile system in the manner described.

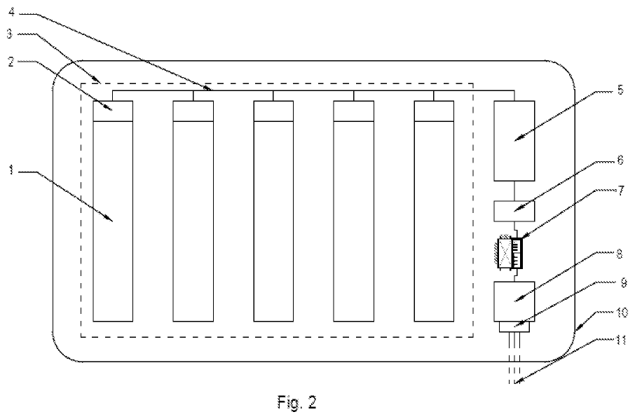

Referring to FIG. 2, according to one embodiment, a mobile system may include an energy storage module (ESM) 1, ESM load balancing and control unit 2, energy storage array 3, power and communication lines 4, power conversion and control unit 5, an electrical switchgear 6, a voltage transformer 7, a distribution switchgear 8, a main power connection box 9, a floating device (for example a barge) 10, and shore power connection lines 11. The energy storage module (ESM) is a module that can be one of many different energy storage technologies including batteries, fuel cells, mechanical storage devices and capacitors. The ESM is able to charge, retain and discharge energy at a later time. ESM load balancing and control unit 2 monitors the individual ESM's to make sure all electrical characteristics and functions are correct during any time. The energy storage array 3 is a number of ESM's and ESM load balancing and control units connected in parallel or series. The power and communication lines 4 enable the power flow and communication signals between the electrical components. The power conversion and control unit 5 inverts the electricity from the ESM from direct current to alternating current and vice versa depending on whether the system is charging or discharging. It also moves electrical energy into or out of an energy storage module. The electrical switchgear 6 is an electrical component used to physically disconnect the power conversion and control unit from the voltage transformer electrically, usually for safety purposes. A voltage transformer 7 steps up and steps down the electricity voltages. A distribution switchgear 8 is an electrical component used to physically disconnect the voltage transformer from the main power connection box electrically, usually for safety purposes. The main power connection box 9 is the primary point of connecting the system electrically when deployed. A floating device 10 is a device used to carry the components on one platform. Shore power connection lines 11 are the high voltage cables used to connect the system to an entity that needs electricity.

In a method according to the present invention more than two mobile systems may be used to supply power to the sites in the manner described herein.

An advantage of a method according to the present invention is the supply of power to a site uninterruptedly without connection to a grid.

Another advantage is that, because two or more mobile systems are used, the mobile systems could be made smaller, which means it is possible the mobile systems can reach, for example, marine locations that larger vessels could not.

Yet another advantage is that a smaller system could be charged more quickly, which means, when there is a need, the mobile systems could be charged quickly and ready for deployment.

A mobile system used in a method according to the present invention could be built on a specially engineered barge, for example, an electric barge, which has an electric storage system to power propulsion. However, unlike an electric barge, the energy storage system on board is not just used for propulsion. The energy storage system may be used to provide electric power to a site, for example, when the grid is disrupted.

A mobile system for use in a method according to the present invention may comprise one or multiple energy storage modules (ESM), one or multiple ESM load balancing and control units, one or multiple energy storage arrays, one or multiple power and communication lines, one or multiple power conversion and control units, one or multiple electrical switchgears, one or multiple voltage transformers, one or multiple distribution switchgears, one or multiple main power connection boxes, one or multiple floating devices (for example a barge), one or multiple shore power connection lines and one or more monitoring and control elements.

An energy storage module can store and supply electrical energy.

A power conversion module moves electrical energy into or out of an energy storage module. A power conversion module dictates the rate at which an energy storage module charges and may convert alternating current to direct current and vice versa.

Monitoring and control elements are responsible for the operation of the energy storage system.

An energy storage module can be one of many different energy storage technologies including batteries, fuel cells, mechanical storage devices and capacitors. A battery module may, for example, include a plurality of battery cells, a battery controller that monitors the cells and a battery cell balancer as described, for example, in U.S. Pat. No. 9,847,654 entitled Battery Energy Storage System and Control System and Applications Thereof.

When the energy storage modules is a battery module, the power conversion and control unit could be a bidirectional inverter as described in Patent U.S. Pat. No. 7,746,669 entitled Bidirectional Battery Power Inverter. A bidirectional inverter converts direct current received from a battery module to alternating current during battery discharge mode, and can convert alternating current to direct current, which is used to charge the battery module. The power rating of the inverter is crucial in enabling the possible quick charging and discharging of the battery.

An example of an electrical switchgear is described in EP1814131 entitled Vacuum Insulated Switchgear. A switchgear may comprise a vacuum circuit breaker for breaking load current or fault current, an earthing switch and a disconnecting switch (both for protecting the safety of workers), a sensor for detecting network voltage and current, and a protection relay.

In order to successfully and practically use a mobile system to transport energy, the system has inherently unique design features.

In one embodiment, the system may be designed with a certain ratio of power to energy, which is controlled by the ratio of the power conversion and control unit rating in relation to the energy storage module rating. As explained, it is crucial for the storage system to have the ability to charge quickly. Thus, one mobile system should be able to charge from zero to full capacity in less time than it takes for a site to consume the energy stored in the other mobile system.

In another embodiment, there can be a dock system to quickly connect the mobile system once it arrives at the location in the vicinity of a power plant or at a location in the vicinity of the site which needs electricity. The dock system may be located on land or in a marine location instead.

In yet another embodiment, there may be an electrical connection apparatus installed on each mobile system and one on the dock system. A connection apparatus may move in, for example, six degrees of freedom to maintain electrical contact when the mobile system is charging and discharging. A connection apparatus counters the movements of the mobile system and maintains electrical contact. A connection apparatus may include a plurality of gimbal frames with pivot assemblies and coupled actuators. See, for example, U.S. Pat. No. 8,179,078 entitled Handheld or vehicle mounted platform stabilization system. The electrical connection can be galvanic or inductive. Galvanic charging uses a cable physically linking the mobile system and the connection on the dock system. Inductive charging uses an electromagnetic field to transfer energy rather than a physical cable.

In a further embodiment and unlike current land-deployed energy storage systems, during transport and operation, the components of a mobile system will be subjected to various forces including shock and vibration. The components are designed with additional bracing and shock absorbers to minimize damage during movement.

In yet another embodiment, the components of the mobile system are designed to withstand marine environments. The components are, for example, sealed to prevent any water or air intrusion. The component surfaces exposed to the atmosphere may be also coated or galvanized to prevent rust. The cathodic protection technique may be to prevent rusting of the components of the mobile system at the risk of rusting. This is accomplished by having the metal surfaces of the mobile system connected to an electrochemical cell whereby the metal surfaces become the cathode of the electrochemical cell. On a barge, for example, there may be a sacrificial metal anode connected to the electrochemical cell. Through a redox reaction, the sacrificial layer rusts while emitting electrons that feed the protected metal layers of the barge and energy storage system on the barge to prevent the protected metal layers from rusting.

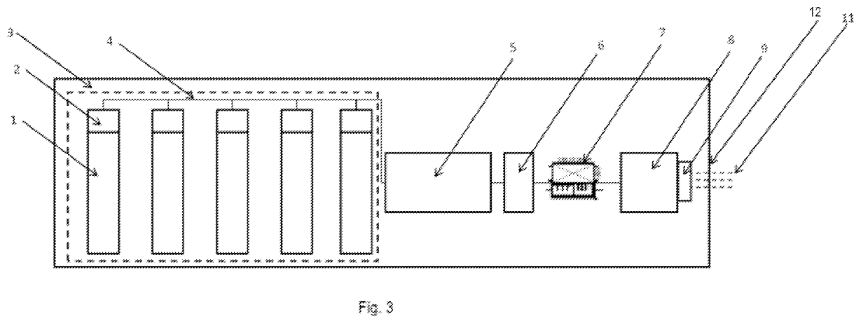

Referring to FIG. 3, in a method according to the second embodiment, instead of a barge or some other marine vessel, the system may be rendered mobile with a trailer 12 and deployed on land. A mobile system that comprises a trailer 12 may be moved from a charging location (i.e. at a vicinity of a power plant or a functional power infrastructure) to a site and back to the charging location by a truck, for example. Alternatively, the mobile system may be transported to a barge and then moved to the site for discharging, and then taken off the barge and moved to the charging location to carry out the method.

The present invention has been described in detail, including the preferred embodiments thereof. However, it will be appreciated that those skilled in the art, upon consideration of the present disclosure, may make modifications and/or improvements on this invention that fall within the scope and spirit of the invention.

1. A method of supplying electric power to a site that consumes electric power, the method comprising:
providing a first mobile system;
providing a second mobile system, each mobile system comprising an energy storage system;
charging the energy storage of the first mobile system;
after charging the energy storage of the first mobile system, causing the first mobile system to travel to a location in a vicinity of the site;
supplying electric power to the site from the first mobile system while the first mobile system is located at the location in the vicinity of the site;
charging the energy storage of the second mobile system at a location in a vicinity of a power plant or other functional power infrastructure;
after charging the energy storage of the second mobile system, causing the second mobile system to travel to a location in a vicinity of the site; and
supplying electric power to the site from the second mobile system while the first mobile system is transported back to a location in a vicinity of a power plant or other functional power infrastructure to recharge;.

2. The method of claim 1, further comprising charging the energy storage of the first mobile system at the location in the vicinity of the power plant.

3. The method of claim 1, wherein the energy storage of the second mobile system is charged in less time than it takes to discharge the energy storage of the first mobile system at the location in the vicinity of the site.

4. The method of claim 1, wherein the energy storage of the second mobile system is charged in less than ten hours and more than half an hour.

5. The method of claim 1, wherein at least one of the mobile systems comprises a marine vessel, and the location in the vicinity of the site is a marine location.

6. The method of claim 1, wherein the energy storage of each mobile system comprises a rechargeable battery, and further comprising charging the battery in each mobile system with an on-board power converter and discharging the battery with the on-board power converter.

7. The method of claim 1, wherein the energy storage in either mobile system is selected from a group consisting of an electrochemical cell, an electrical cell, a mechanical energy storage, a flow battery and fuel cells.

8. The method of claim 1, further comprising electrically connecting the first mobile system to the site via an on-board electrical connection apparatus having at least two to eight degrees of freedom to supply electric power to the site, or electrically connecting the second mobile system to the site via an on-board electrical connection apparatus having at least two to eight degrees of freedom to supply electric power to the site.

9. The method of claim 1, further comprising monitoring the supply of electric power to the site with a monitoring device on-board the first mobile system, or monitoring the supply of electric power to the site with a monitoring device on-board the second mobile system.

10. The method of claim 1, further comprising controlling the supply of electric power to the site with a control element on-board the first mobile system, or controlling the supply of electric power to the site with a control element on-board the second mobile system.

11. The method of claim 1, further comprising remotely controlling movement of the first mobile system or the second mobile system.

12. The method of claim 1, wherein the first mobile system is positioned at the location in the vicinity of the site before the site is disconnected from a power grid.

13. The method of claim 1, wherein at least one of the mobile systems comprises a barge.

14. The method of claim 1, wherein at least one of the mobile systems comprises a trailer.
